(19) United States
(12) Patent Application Publication
(10) Pub. No.: US 2024/0097225 A1
(43) Pub. Date: Mar. 21, 2024

(54) Process for Efficient Recycling of Cathode Active Materials

(71) Applicant: Nano One Materials Corp, Burnaby (CA)

(72) Inventor: Stephen A. Campbell, Burnaby (CA)

(21) Appl. No.: 18/244,700

(22) Filed: Sep. 11, 2023

Related U.S. Application Data
(60) Provisional application No. 63/407,842, filed on Sep. 19, 2022.

(51) Int. Cl. H01M 10/54; C22B 7/00; H01M 4/04; H01M 4/505; H01M 4/525

(52) U.S. Cl. CPC H01M 10/54; C22B 7/007; H01M 4/04; H01M 4/505; H01M 4/525; H01M 2004/028

(57) ABSTRACT

A process of forming recycled cathode active material, particularly from depleted cathode active material from a battery, comprising:
forming black mass from the depleted cathode active material;
digesting the black mass with a carboxylic acid to form delithiated cathode active material precursor;
adding virgin lithium salt to the delithiated cathode active material precursor to form cathode active material precursor; and
calcining the cathode active material precursor to form the recycled cathode active material.

### CROSS-REFERENCE TO RELATED APPLICATIONS

The present application claims priority to pending U.S. Provisional Application No. 63/407,842 filed Sep. 19, 2022 which is incorporated herein by reference.

### FIELD OF THE INVENTION

The present invention is related to batteries and particularly recycling of the cathode active material (CAM) of a battery.

### BACKGROUND

Batteries, as an energy storage device, are now ubiquitous in society. Devices utilizing batteries as an energy storage device are in wide-spread use in the communication industry, such as in cell phones and the like, the tool industry, such as yard or hand tools and the like, the transportation industry, such as vehicles and the like, the medical industry, such as pace-makers and the like, and virtually every sector of commerce where energy storage is necessary.

The wide-spread and expanding use of batteries has placed supply pressures on the raw materials used which, in some cases, has driven up the cost of the raw materials due to the inability of the supply to meet the demand. The increased use has also caused issues related to disposal of the depleted batteries.

There is now a world-wide need for a way to recycle batteries, particularly the cathode active material of batteries. The primary components used in CAM are lithium, nickel, manganese, cobalt and aluminum with the two primary batteries of significant commercial interest being LiMO₂ or LiM₂O₄; wherein M is primarily combinations of nickel, manganese, cobalt and aluminum with other metals of lesser quantity.

Current efforts related to recycling of depleted CAM are primarily based on hydrothermal digestion temperatures of at least 170° C. in a sealed vessel resulting in the formation of metal sulphates and lithium hydroxide. In subsequent workup to reform CAM the metal sulfates ultimately generate a sodium sulfate salt which renders the recycling process unsustainable at market volumes.

The present invention is related to a method of forming recycled CAM from depleted CAM allowing for the recovery the metal salts in a form wherein the metal salts can be converted into recycled CAM without the formation of sodium sulfate.

### SUMMARY OF THE INVENTION

It is an object of the invention to provide a method for forming recycled CAM from depleted CAM wherein the depleted CAM is preferably from a battery.

A particular feature of the invention is the ability to form recycled CAM from depleted CAM without the formation of sulfates and without the necessity of high temperatures and pressures typically associated with a hydrothermal process or filtration of the black mass formed from depleted CAM.

Another feature is the ability to form recycled CAM from depleted CAM without loss of the metals of the cathode.

A particular advantage is the ability to form recycled CAM from depleted CAM wherein the recycled CAM has a different ratio of metals than the depleted CAM thereby allowing for the conversion of depleted CAM to a recycled CAM which is rich in at least one metal relative to the depleted CAM.

These and other embodiments, as will be realized, are provided in a process of forming recycled cathode active material comprising:
forming black mass from depleted cathode active material;
digesting the black mass with a carboxylic acid to form delithiated cathode active material precursor;
adding virgin lithium salt to the delithiated cathode active material precursor to form cathode active material precursor; and
calcining the cathode active material precursor to form the recycled cathode active material.

Yet another embodiment is provided in a process for recycling cathode active material from a battery comprising:
removing depleted cathode active material from the battery;
forming black mass from the depleted cathode active material;
digesting the black mass with a carboxylic acid to form a cathode active material precursor;
adding a virgin lithium salt to the cathode active material precursor; and calcining the cathode active material precursor to form a recycled cathode active material.

### BRIEF DESCRIPTION OF THE DRAWING

FIG. 1 is a flow chart representation of the invention.

FIG. 2 is a XRD graph of CAM precursor.

FIG. 3 is a graphical representation of particle size of CAM precursor.

FIG. 4 is an XRD pattern of recycled CAM.

FIG. 5 is a graphical representation of particle size of recycled CAM.

FIGS. 6A-6C graphically illustrates the advantages of the invention.

### DESCRIPTION

The present invention is related to a method, and system, for forming recycled CAM by retrieving the metal from depleted CAM without the formation of sulfates such as sodium sulfate. More specifically, the present invention is related to a method, and system, for recovery the metals from depleted CAM wherein the metal is suitable for use in the formation of recycled CAM optionally having essentially the same stoichiometry without addition of substantial amounts of virgin metal salts.

Depleted CAM is typically recycled from a battery without limit thereto as the process can be utilized for the formation of recycled CAM from CAM recovered from the production stream which fails to be included in a battery. When recycled from a battery it is preferable to isolate the depleted CAM from the other components of the battery such as the anode, separator, electrolyte, current collectors, carbon, encasement and any other component not part of the depleted CAM.

For the purposes of the present invention virgin CAM is a CAM formed from metal salts not previously part of a CAM. Depleted CAM is a CAM which was previously in the crystalline form consistent with LiM₂O₄ or LiMO₂ as further described herein. Black mass is formed from depleted CAM which has been removed from a battery and treated, preferably by heat, to provide a material which is rich in the metals consistent with CAM. CAM precursor is a metal carboxylate wherein the metals are from a depleted CAM. Recycled CAM is CAM formed from metals previously utilized in depleted CAM and preferably at least 20 wt % of the metals of the recycled CAM is from metals previously utilized in depleted CAM, more preferably at least 50 wt % of the metals and even more preferably at least 80 wt %.

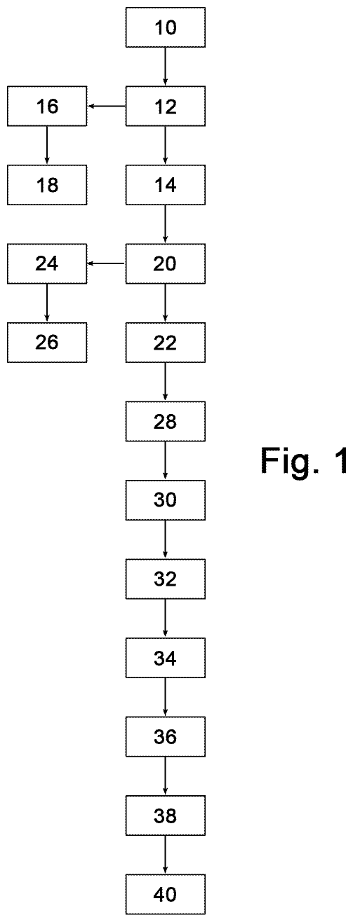

The invention will be described with reference to FIG. 1 wherein the invention is represented in a flow-chart. In FIG. 1, at least one battery and preferably multiple batteries wherein at least one battery and preferably all batteries comprise depleted CAM is collected in 10. The batteries are segmented at 12 into compliant batteries with depleted CAM comprising LiMO₂ or LiM₂O₄, 14, from non-compliant batteries comprising cathode materials which do not comprise LiMO₂ or LiM₂O₄, 16, or which comprise an amount of depleted CAM comprising LiMO₂ or LiM₂O₄ which is insufficient for recycling. The non-compliant batteries are removed, 18, from the process stream for separate treatment the nature of which is not limited by the instant invention. The compliant batteries are preferably discharged and then disassembled at 20, wherein the battery cell comprising depleted CAM, is physically separated from the other components of the battery cell such as casing, shells, connecting tabs, electronic components such as battery management elements, foils, shields, etc. resulting in an isolated battery cell, 22, and a waste stream, 24. The waste stream is removed, 26, from the process stream for separate treatment the nature of which is not limited by the instant invention. The battery cell comprises, at least, the depleted CAM, an anode, a dielectric, and an enclosure. The battery cell is preferably chopped or diced, 28, in a manner sufficient to maintain safety. Without limit thereto, the battery cell can be chopped or diced in a non-volatile liquid, such as water, or in an atmosphere which inhibits combustion to protect against the unlikely event of an energy discharge. The depleted CAM can be partially isolated by ultrasound flow at 30. The graphite of the anode, silicon from the cathode materials and any other components to can be removed by flotation or filtration at 32. Fluoride, residual carbon and binders can be burnt off at 34 resulting in isolation of black mass, 36, wherein the black mass comprises large quantities of the components of CAM and specifically lithium, nickel, manganese, cobalt or aluminum. Black mass is distinguished from depleted CAM herein since the depleted CAM is heated to remove volatile components and therefore some alteration of chemical structure may occur during the heating process and the lattice may be altered at least in part relative to depleted CAM. The black mass is then be converted to a CAM precursor, 38, as further described herein and calcined, 40, to form recycled CAM as further described herein.

In the inventive process the black mass is digested directly by a carboxylic acid, preferably a multicarboxylic acid, more preferably a dicarboxylic acid and most preferably oxalic acid to produce a metal carboxylate. In an embodiment of the invention the black mass may be pulverized prior to digesting with carboxylic acid. A particular feature of the invention is the ability to form recycled CAM from depleted CAM at temperatures of no more than 100° C. under ambient, or atmospheric, pressure. For the purposes of the present invention ambient, or atmospheric, pressure is defined as having a pressure of the local environment without supplemental pressure increase or decrease. The inventive process eliminates the necessity of a hydrothermal process which typically requires heating up to at least about 170° C. in a sealed vessel wherein the pressure increases dramatically.

In a preferred embodiment the depleted CAM is converted to recycled CAM comprising a lithium metal compound in a spinel crystal structure defined by Formula I:

LiNiₓMn_{y}X_{z}E_{w}O₄ Formula I
wherein E is an optional dopant; and
x+y+z+w=2 and w≤0.2; or
a rock-salt crystal structure defined by Formula II;

LiNiₐMn_{b}X_{c}G_{d}O₂ Formula II
wherein G is an optional dopant;
X is Co or Al; and
wherein a+b+c+d=1 and d≤0.1.

In a preferred embodiment the spinel crystal structure of Formula I has 0.4≤x≤0.6; 1.4≤y≤1.6 and z≤0.9. More preferably 0.5≤x≤0.55, 1.45≤y≤1.5 and z≤0.05. In a preferred embodiment neither x nor y is zero. In Formula I it is preferable that the Mn/Ni ratio is no more than 4, preferably at least 2.33 to no more than 3.4 and most preferably at least 2.7 to no more than 3.4.

In a preferred embodiment the rock-salt crystal structure of Formula II is a high nickel NMC wherein 0.5≤a≤0.9 and more preferably 0.58≤a≤0.62 as represented by NMC 622 or 0.78≤a≤0.82 as represented by NMC 811. In a preferred embodiment a=b=c as represented by NMC 111. The term NMCxxx is a shorthand notation used in the art to represent the nominal relative ratio of nickel, manganese and cobalt. NMC811, for example, represents LiNi_{0.8}Mn_{0.1}X_{0.1}O₂.

In an embodiment of the invention black mass is digested with a carboxylic acid, preferably in the presence of an acid and most preferably nitric acid, to form a CAM precursor comprising a mixture of metal salts in accordance with the following equation wherein with oxalate (OX) as a representative carboxylic acid:

LiᵤNiₓMn_{y}X_{z}E_{w}O₄+OX→uLi⁺+xNiOX+yMnOX+zXOX+wEOX
wherein the lithium may be sub-stoichiometric due to the use of depleted CAM or at least some lithium being removed during the digestion process for form delithiated CAM precursor. Lithium, preferably as lithium hydroxide or lithium carbonate, is added to the delithiated CAM precursor to return the lithium and metals to the proper stoichiometry followed by calcining to achieve the recycled CAM represented by the following equation:

Li+xNiOX+yMnOX+zXOX+wEOX→LiNiₓMn_{y}X_{z}E_{w}O₄
wherein at least a portion of Li⁺ is from virgin lithium salt added to account for lithium deficiencies.

In another embodiment of the invention a black mass is digested with a carboxylic acid, preferably in the presence of an acid and most preferably nitric acid, to form a delithiated CAM precursor comprising a mixture of metal salts in accordance with the following equation wherein with oxalate (OX) as a representative carboxylic acid:

LiᵥNiₐMn_{b}X_{c}G_{d}O₂+OX→vLi⁺+aNiOX+bMnOX+cXOX+dGOX
wherein the lithium may be sub-stoichiometric due to the use of depleted CAM or at least some lithium being removed during the digestion process for form delithiated CAM precursor. Lithium, preferably as lithium hydroxide or lithium carbonate, is added to form the stoichiometric CAM precursor followed by calcining to achieve the recycled CAM represented by the following equation:

Li⁺+aNiOX+bMnOX+cXOX+dGOX→LiNiₐMn_{b}X_{c}G_{d}O₂
wherein at least a portion of Li⁺ is from virgin lithium salt added to account for lithium deficiencies.

In the formulas throughout the specification, the lithium is defined stoichiometrically to balance charge with the understanding that the lithium is mobile between the anode and cathode. Therefore, at any given time the cathode may be relatively lithium rich or relatively lithium depleted. In a lithium depleted CAM the lithium will be below stoichiometric balance and when charged the lithium may be above stoichiometric balance. Likewise, in formulations listed throughout the specification the metals are represented in charge balance with the understanding that the metal may be slightly rich or slightly depleted, as determined by elemental analysis, due to the inability to formulate a perfectly balanced stoichiometry in practice. In the present application for a stoichiometric representation, such as in NMC811, the stoichiometric ratio is ±1 molar % due to manufacturing and elemental analysis variations. By way of non-limiting example, NMC811 or the equivalent representation LiNi_{0.8}Mn_{0.1}Co_{0.1}O₂, is intended to represent LiNi_{0.792-0.808}Mn_{0.099-0.101}Co_{0.099-0.101}O₂ with the sum of the molar amounts of Ni, Mn and Co equal to 1.

Dopants can be added to enhance the properties of the oxide such as electronic conductivity and stability. The dopant is preferably a substitutional dopant added in concert with the primary nickel, manganese and optional cobalt or aluminum. The dopant preferably represents no more than 10 mole % and preferably no more than 5 mole % of the oxide. Preferred dopants include Al, Gd, Ti, Zr, Mg, Ca, Sr, Ba, Mg, Cr, Cu, Fe, Zn, V, Bi, Nb and B with Al and Gd being particularly preferred with the understanding that Al as a dopant would be utilized when Al is not a primary component represented by X in Formula I or Formula II. Dopants and coating materials may be added to the reactor either as carboxylates, carbonates, oxides or metals as appropriate to make the desired composition.

A particular feature of the invention is the ability to maintain stoichiometry of the metals through the recycle process. Additional metals, such as a lithium niobate coating, will form a metal salt through the recycle process likely as an oxalate. Upon calcining to form the compound of Formula I or Formula II, the niobium will form either a niobium dopant or a lithium niobate coating as described in U.S. Published Appl. No. 20210028448 which is incorporated herein by reference.

Recycled CAM is preferably formed from the metal carboxylate by a process as detailed in U.S. patent application Ser. No. 17/743,932 filed May 13, 2022, U.S. Published Appl. No. 20220064019, U.S. Published Appl. No. 20210359300, U.S. Published Appl. No. 20210028448 and U.S. Published Appl. No. 20190372129 each of which is incorporated herein by reference.

For the purposes of the present invention virgin metal salts are metal salts comprising metals which have not been previously used in CAM or metal salts added to a CAM precursor to alter the stoichiometric ratio of the metals. Preferred virgin metal salts are metal hydroxides or metal carboxylates and particularly metal oxalates.

An advantage of the invention is the ability to recapture virtually all of the metal of depleted CAM with minimal loss since there is no necessity to filter the metal salts prepared from the black mass. Therefore, if a recycled CAM is to be prepared with the same stoichiometric ratio of metals, such as the case in forming NMC 111, as recycled CAM, from NMC 111, as depleted CAM, there is no need to include virgin metal salts. If the stoichiometry is to be changed, such as forming NMC 811, as recycled CAM, from NMC 111, as depleted CAM, virgin metal must be added to alter the ratio. Metal from the depleted CAM, black mass or CAM precursor cannot be easily removed therefore metal, and preferably virgin metal, is preferably added to alter the stoichiometry. By way of non-limiting example, NMC 111 has the nominal formula LiNi_{0.33}Mn_{0.33}X_{0.33}O₂ and NMC 811 has the nominal formula LiNi_{0.8}Mn_{0.1}X_{0.1}O₂. To convert depleted NMC 111 to recycled NMC 811 nickel salts must be added to the extent necessary to achieve about 8 times the molar ratio of nickel relative to manganese or cobalt. Alternatively, if recycled NMC 111 is to be formed from depleted NMC 811 a sufficient amount of manganese and cobalt must be added to equal the molar ratio of nickel. One of skill in the art could easily determine the amount of metal necessary to adjust the stoichiometry as needed.

For the purposes of the present invention, virgin lithium salts are lithium salts which are added to a metal carboxylate slurry, or CAM precursor, formed from the black mass prior to drying to achieve the proper stoichiometric ratio of lithium to metal prior to calcining to form the recycled CAM. Preferred virgin lithium salts are lithium hydroxide or lithium carbonate.

The stoichiometry of lithium must be determined as would be understood and which is well within the capability of one of skill in the art. The moles of lithium, relative to the metals, varies since the state of charge of the CAM being utilized as depleted CAM can vary dramatically. Furthermore, lithium can be lost in the process of separating the depleted CAM from the rest of the battery components such as the carbon, electrolyte, collectors, separators, etc. Therefore, the lithium concentration is determined after digestion and sufficient virgin lithium is added to balance the stoichiometry prior to drying and calcining.

After formation of the recycled CAM it is preferable to form a battery comprising the recycled CAM as the cathode active material. The formation of a battery comprising recycled CAM does not vary from the process utilizing virgin CAM and therefore further elaboration on the process for forming a battery would be well understood by those of skill in the art.

### EXAMPLES

Fully lithiated niobium coated NMC811 CAM, independent of a battery and representative of black mass formed from depleted CAM, was added to a solution of oxalic acid and water in a 500 mL three necked round bottom flask with a condenser. The flask was placed in a heating mantel and the temperature was maintained at 95° C. on a stir plate. The molar ratio of depleted CAM and oxalic acid was 1.00:1.02, representing a 0.5 mole % excess oxalic acid, and the solids content was about 58%. The reaction was allowed to proceed for 25 hours. The slurry was then mixed for 1 hour before spray drying to obtain a CAM precursor having a ratio of Li/Ni/Mn/Co consistent with NMC811. The CAM precursor was calcined at 837° C. for 15 hours to obtain the recycled CAM.

The stoichiometry and the concentration of Li, Ni, Mn, Co and Nb was determined by inductively coupled plasma optical emission spectroscopy (ICP-OES). The crystal structure of the material was characterized by X-ray diffraction (XRD) with a Cu Kα radiation source. The gross morphology of the samples was characterized by scanning electron microscope (SEM). High-angle annular dark-field (HAADF) scanning transition electron microscopy (STEM) and energy-dispersive X-ray spectroscopy (EDX) were used to check the location of niobium in the recycled CAM.

For the fabrication of the cathode, the recycled CAM was mixed with carbon black and PVDF (90:7:3) in n-methyl-2-pyrrolidone (NMP) forming a slurry. The slurry was coated onto carbon coated Al foil and dried overnight at 80° C. in a vacuum oven to provide an electrode. The electrode was calendared and punched into small pieces with a diameter of 1.4 cm. Size 2023 coin-type half cells were assembled in a glovebox filled with high-purity argon using Li metal as anode and polypropylene PP as separator. The electrolyte solution was 1M liPF₆ in ethylene carbonate (EC)/ethyl methyl carbonate (EMC)/dimethyl carbonate (DMC) wherein the EC/EMC/DMC were in a 1:1:1 ratio by volume mixed with 1% vinylene carbonate. The loading mass of the recycled CAM in the electrode was about 4-5 mg/cm². Electrochemical measurements were performed in the voltage range of 2.8-4.3 V at 25° C.

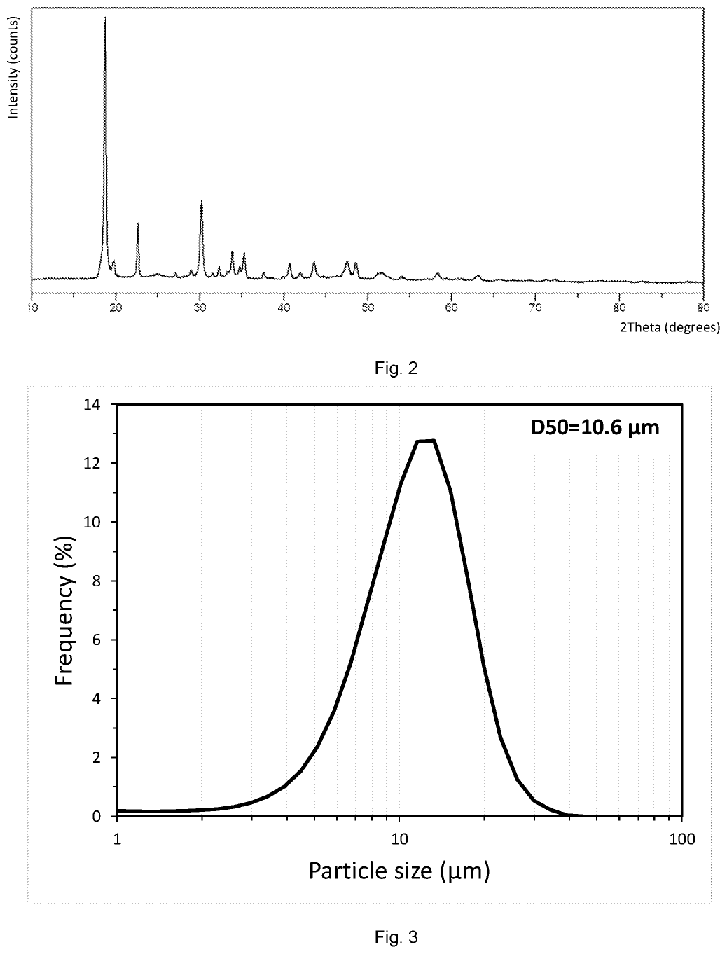

FIG. 2 shows the XRD pattern of the CAM precursor. The peaks can be indexed to monoclinic lithium oxalate structure and monoclinic α-Ni dihydrate oxalate structure. ICP analysis of the CAM precursor indicated a molar ratio of the Ni, Mn and Co to be 8:1:1 indicating no loss of the transition metals and acceptable proportion of metal ions in the precursor. The lithium:transition metal ratio was indicated to be about 1.06:1.00 which is slightly higher than the 1.03:1.00 NMC811 CAM starting material and, therefore, there as no need to add lithium salts to achieve stoichiometric balance. The niobium was indicated to be about 0.52 wt %.

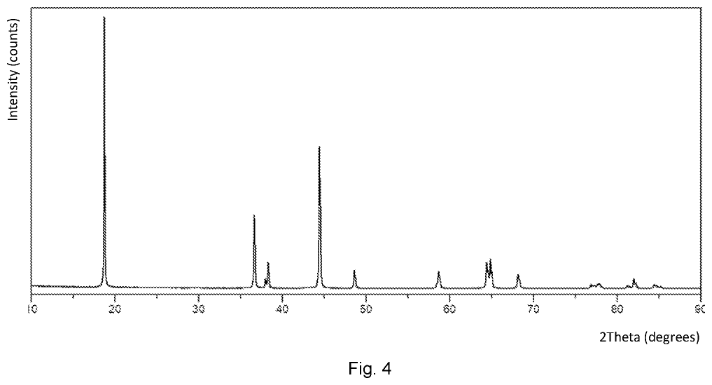

The particles were confirmed by SEM to be spherical shaped having a particle size with a D50 value of 10.6 μm as indicated in the graphical representation of particle size in FIG. 3. Tapped density of the CAM precursor was determined to be 0.52 g/ml. The CAM precursor was calcined at 837° C. for 15 hours followed by analysis of the resulting recycled CAM.

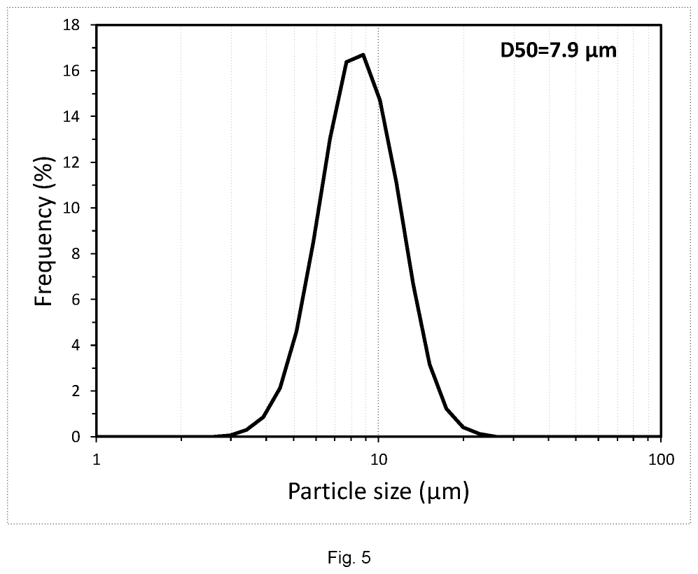

After calcining the composition of the recycled CAM was determined to have a nominal lithium content of 1.05 mole per mole of Ni/Mn/Co combined and the Ni/Mn/Co ratio was 0.80/0.10/0.10. The XRD pattern of the recycled CAM is provided in FIG. 4 which was indexed to the hexagonal structure with the R 3̅ m space group. Single phase crystals with no unidentified/impurity peaks from the process was detected confirming the successful recycling of depleted NMC811 CAM to recycled NMC811 CAM.

Table 1 shows the R values and lattice parameters of recycled CAM. The R1 value, which is often used as an indication of cation mixing in NMC cathode materials, is higher than 1.2 which shows minimal and desirable amount of cation mixing. The a and c lattice parameters are 2.87 Å and 14.20 Å, respectively.

TABLE 1
XRD parameters of recycled NMC811

| | R1 | R2 | a | c | |
|---|---|---|---|---|---|
| Material | (Ideal <1.2) | (Ideal <0.5) | (Ang.) | (Ang.) | c/a |
| Recycled CAM | 1.23 | 0.42 | 2.87 | 14.20 | 4.94 |

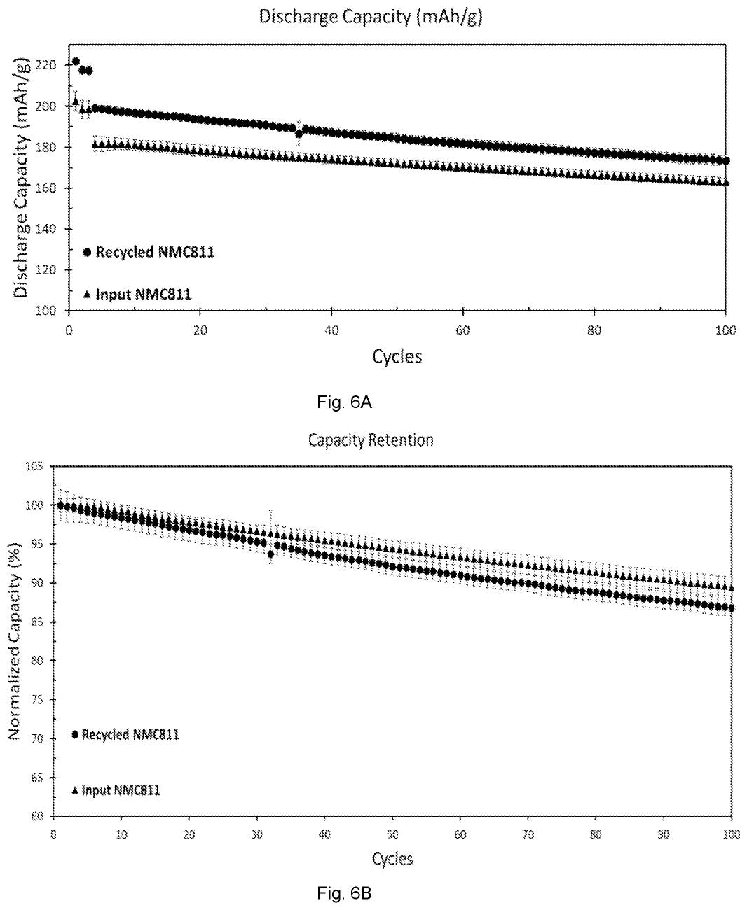

Particle size distribution of the recycled NMC811 CAM is presented in FIG. 5. SEM indicated that the spherical particle morphology had been restored.

To verify that niobium exist as a coating layer on the surface of each primary particle of the recycled NMC811, the sample was cross sectioned and analyzed by Scanning Transmission Electron Microscopy (STEM) and Energy Dispersive X-ray Spectroscopy (EDX). The results indicated that there is a combination of thin niobium coating layer at the surface and edges of the particles and niobium doping within the particles.

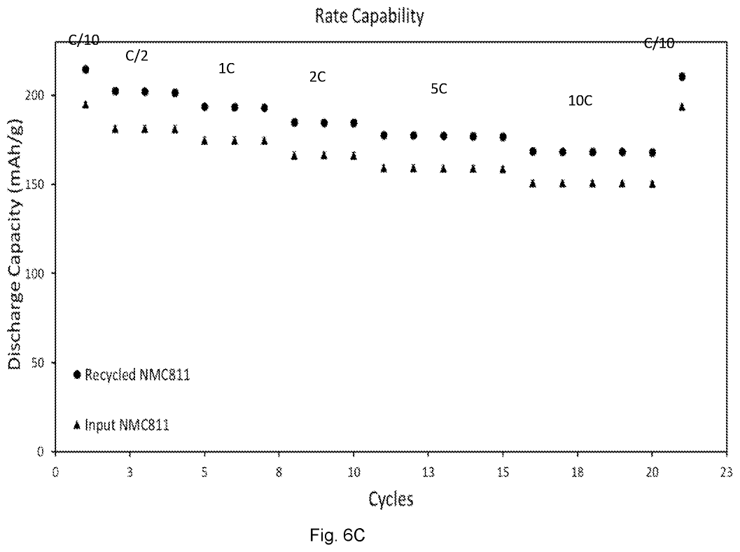

Half type, 2032 sized, coin cells were fabricated to identify electrochemical performance of recycled NMC811 materials. FIGS. 6A-6C graphically illustrate the electrochemical performance, specific discharge capacity and the capacity retention versus cycle number and rate capabilities of the input and recycled NMC811 material. As can be seen from FIGS. 6A-6C the recycled NMC811 shows higher discharge capacities compared to the input NMC811 however, it falls short in capacity retention. The recycled sample also exhibits a good rate capability with a good re-balance after going through harsh conditions (5C and 10C). Table 2 summarizes the electrochemical performance of the recycled NMC compared to input NMC811 conditioned at C/20 mAh/g, C/20 Columbic efficiency (CE), C/10 (mAh/g) and 1^{st} C/10 Columbic efficiency CE).

TABLE 2
Summary of the electrochemical performance
of initial and recycled NMC811

| | C/20 | C/20 | C/10 | 1^{st} C/ | Capacity |
|---|---|---|---|---|---|
| Material | mAh/g | CE | mAh/g | 10 CE | Retention |
| Input NMC | 202.5 | 89% | 198.4 | 96.8% | 89% |
| Recycled NMC | 222.0 | 93% | 217.7 | 97.5% | 87% |

The results demonstrate effective formation of recycled CAM at temperatures of no more than 100° C. under atmospheric pressure. The recycling process offers the possibility to recycle depleted CAM without the need for complex separation processes and especially without high temperature, high pressure and filtering of the black mass. Black mass, formed as isolated depleted CAM, can be converted to carboxylates, preferably oxalates, which serves as a CAM precursor for the formation of recycled CAM. X-ray diffraction and inductively coupled plasma optical emission spectroscopy confirms the excellent purity of the recycled CAM. The morphology of the recycled CAM shows spherical particles which are preferable in industry. Furthermore, the electrochemical performance of coin half-cells containing the recycled CAM showed specific discharge capacity of 217.7 mAh/g at first C/10 cycle. This method can offer a scalable alternative to the existing recycling processes.

The invention has been described with reference to preferred embodiments without limit thereto. One of skill in the art would realize additional embodiments which are described and set forth in the claims appended hereto.

Claimed is:

1. A process of forming recycled cathode active material comprising:
forming black mass from depleted cathode active material;
digesting said black mass with a carboxylic acid to form delithiated cathode active material precursor;
adding virgin lithium salt to said delithiated cathode active material precursor to form cathode active material precursor; and
calcining said cathode active material precursor to form said recycled cathode active material.

2. The process of forming recycled cathode active material of claim 1 wherein said depleted cathode active material is defined by Formula I:
LiNiₓMn_{y}X_{z}E_{w}O₄ Formula I
wherein E is an optional dopant;
x+y+z+w=2;
w≤0.2; and
u≤1; or
Formula II;
LiᵥNiₐMn_{b}X_{c}G_{d}O₂ Formula II
wherein G is an optional dopant;
X is Co or Al;
a+b+c+d=1;
v≤1;
and d≤0.1.

3. The process of forming recycled cathode active material of claim 2 wherein in said Formula I:
0.4≤x≤0.6;
1.4≤y≤1.6;
and z≤0.9.

4. The process of forming recycled cathode active material of claim 3 wherein in said Formula I:
0.5≤x≤0.55;
1.45≤y≤1.5; and
z≤0.05.

5. The process of forming recycled cathode active material of claim 2 wherein in said Formula I neither x nor y is zero.

6. The process of forming recycled cathode active material of claim 2 wherein in said Formula I has a Mn/Ni ratio of no more than 4.

7. The process of forming recycled cathode active material of claim 6 wherein said Mn/Ni ratio is at least 2.33 to no more than 3.4.

8. The process of forming recycled cathode active material of claim 7 wherein said Mn/Ni ratio is at least 2.7 to no more than 3.4.

9. The process of forming recycled cathode active material of claim 2 wherein in said Formula II 0.5≤a≤0.9.

10. The process of forming recycled cathode active material of claim 9 wherein in said Formula II 0.58≤a≤0.62.

11. The process of forming recycled cathode active material of claim 9 wherein in said Formula II 0.78≤a≤0.82.

12. The process of forming recycled cathode active material of claim 2 wherein said E or said G is selected from the group consisting of Al, Gd, Ti, Zr, Mg, Ca, Sr, Ba, Mg, Cr, Cu, Fe, Zn, V, Bi, Nb and B.

13. The process of forming recycled cathode active material of claim 12 wherein said E or said G is selected from the group consisting of Al and Gd.

14. The process of forming recycled cathode active material of claim 1 wherein said recycled cathode active material is defined by Formula I:
LiNiₓMn_{y}X_{z}E_{w}O₄ Formula I
wherein E is an optional dopant; and
x+y+z+w=2 and w≤0.2; or
Formula II;
LiNiₐMn_{b}X_{c}G_{d}O₂ Formula II
wherein G is an optional dopant;
X is Co or Al; and
wherein a+b+c+d=1 and d≤0.1.

15. The process of forming recycled cathode active material of claim 14 wherein in said Formula I:
0.4≤x≤0.6;
1.4≤y≤1.6;
and z≤0.9.

16. The process of forming recycled cathode active material of claim 15 wherein in said Formula I:
0.5≤x≤0.55;
1.45≤y≤1.5; and
z≤0.05.

17. The process of forming recycled cathode active material of claim 14 wherein in said Formula I neither x nor y is zero.

18. The process of forming recycled cathode active material of claim 14 wherein in said Formula I has Mn/Ni ratio is no more than 4.

19. The process of forming recycled cathode active material of claim 18 wherein said Mn/Ni ratio is at least 2.33 to no more than 3.4.

20. The process of forming recycled cathode active material of claim 19 wherein said Mn/Ni ratio is at least 2.7 to less than 3.4

21. The process of forming recycled cathode active material of claim 14 wherein in said Formula II 0.5≤a≤0.9.

22. The process of forming recycled cathode active material of claim 21 wherein in said Formula II 0.58≤a≤0.62.

23. The process of forming recycled cathode active material of claim 21 wherein in said Formula II 0.78≤a≤0.82.

24. The process of forming recycled cathode active material of claim 14 wherein said E or said G is selected from the group consisting of Al, Gd, Ti, Zr, Mg, Ca, Sr, Ba, Mg, Cr, Cu, Fe, Zn, V, Bi, Nb and B.

25. The process of forming recycled cathode active material of claim 24 wherein said E or said G is selected from the group consisting of Al and Gd.

26. The process of forming recycled cathode active material of claim 1 wherein said depleted cathode active material and said recycled cathode active material have the same molar ratios of Ni, Mn, Co and Al.

27. The process of forming recycled cathode active material of claim 1 wherein said depleted cathode active material and said recycled cathode active material do not have the same molar ratios of Ni, Mn, Co and Al.

28. The process of forming recycled cathode active material of claim 27 further comprising adding a virgin metal salt prior to said drying.

29. The process of forming recycled cathode active material of claim 28 wherein said virgin metal salt is a metal hydroxide or a metal carboxylate.

30. The process of forming recycled cathode active material of claim 29 wherein said virgin metal salt is a metal oxalate.

31. The process of forming recycled cathode active material of claim 1 wherein said carboxylic acid is a multicarboxylic acid.

32. The process of forming recycled cathode active material of claim 31 wherein said carboxylic acid is a dicarboxylic acid.

33. The process of forming recycled cathode active material of claim 1 wherein said carboxylic acid is selected from the group consisting of oxalic acid, acetic acid and malic acid.

34. The process of forming recycled cathode active material of claim 33 wherein said carboxylic acid is oxalic acid.

35. The process of forming recycled cathode active material of claim 1 wherein said virgin lithium salt is selected from the group consisting of lithium hydroxide and lithium carbonate.

36. The process of forming recycled cathode active material of claim 1 wherein said digesting is at a temperature of no more than 100° C.

37. The process of forming recycled cathode active material of claim 1 wherein said digesting is at ambient pressure.

38. A process for forming a battery comprising forming a recycled cathode active material of claim 1 followed by formation of an anode, separator, electrolyte and connectivity.

39. A process for recycling cathode active material from a battery comprising:
removing depleted cathode active material from said battery;
forming black mass from said depleted cathode active material;
digesting said black mass with a carboxylic acid to form a cathode active material precursor;
adding a virgin lithium salt to said cathode active material precursor; and
calcining said cathode active material precursor to form a recycled cathode active material.

40. The process for recycling cathode active material from a battery of claim 39 wherein said cathode active material is defined by Formula I:
LiNiₓMn_{y}Co_{z}E_{w}O₄ Formula I
wherein E is an optional dopant; and
x+y+z+w=2 and w≤0.2; or
Formula II;
LiNiₐMn_{b}X_{c}G_{d}O₂ Formula II
wherein G is an optional dopant;
X is Co or Al; and
wherein a+b+c+d=1 and d≤0.1.

41. The process for recycling cathode active material from a battery of claim 40 wherein in said Formula I:
0.5≤x≤0.6;
1.4≤y≤1.5;
and z≤0.9.

42. The process for recycling cathode active material from a battery of claim 41 wherein in said Formula I:
0.5≤x≤0.55;
1.45≤y≤1.5; and
z≤0.05.

43. The process for recycling cathode active material from a battery of claim 40 wherein in said Formula I neither x nor y is zero.

44. The process for recycling cathode active material from a battery of claim 40 wherein in said Formula I a Mn/Ni ratio is no more than 3.

45. The process for recycling cathode active material from a battery of claim 44 wherein said Mn/Ni ratio is at least 2.33 to less than 3.

46. The process for recycling cathode active material from a battery of claim 45 wherein said Mn/Ni ratio is at least 2.6 to less than 3.

47. The process for recycling cathode active material from a battery of claim 40 wherein in said Formula II 0.5≤a≤0.9.

48. The process for recycling cathode active material from a battery of claim 47 wherein in said Formula II 0.58≤a≤0.62.

49. The process for recycling cathode active material from a battery of claim 47 wherein in said Formula II 0.78≤a≤0.82.

50. The process for recycling cathode active material from a battery of claim 40 wherein said E or said G is selected from the group consisting of Al, Gd, Ti, Zr, Mg, Ca, Sr, Ba, Mg, Cr, Cu, Fe, Zn, V, Bi, Nb and B.

51. The process for recycling cathode active material from a battery of claim 50 wherein said E or said G is selected from the group consisting of Al and Gd.

52. The process for recycling cathode active material from a battery of claim 39 wherein said recycled cathode active material is defined by Formula I:
LiNiₓMn_{y}Co_{z}E_{w}O₄ Formula I
wherein E is an optional dopant; and
x+y+z+w=2 and w≤0.2; or
Formula II;
LiNiₐMn_{b}X_{c}G_{d}O₂ Formula II
wherein G is an optional dopant;
X is Co or Al; and
wherein a+b+c+d=1 and d≤0.1.

53. The process for recycling cathode active material from a battery of claim 52 wherein in said Formula I:
0.5≤x≤0.6;
1.4≤y≤1.5;
and z≤0.9.

54. The process for recycling cathode active material from a battery of claim 53 wherein in said Formula I:
0.5≤x≤0.55;
1.45≤y≤1.5; and
z≤0.05.

55. The process for recycling cathode active material from a battery of claim 52 wherein in said Formula I neither x nor y is zero.

56. The process for recycling cathode active material from a battery of claim 52 wherein in said Formula I a Mn/Ni ratio is no more than 3.

57. The process for recycling cathode active material from a battery of claim 56 wherein said Mn/Ni ratio is at least 2.33 to less than 3.

58. The process for recycling cathode active material from a battery of claim 57 wherein said Mn/Ni ratio is at least 2.6 to less than 3.

59. The process for recycling cathode active material from a battery of claim 52 wherein in said Formula II 0.5≤a≤0.9.

60. The process for recycling cathode active material from a battery of claim 59 wherein in said Formula II 0.58≤a≤0.62.

61. The process for recycling cathode active material from a battery of claim 59 wherein in said Formula II 0.78≤a≤0.82.

62. The process for recycling cathode active material from a battery of claim 52 wherein said E or said G is selected from the group consisting of Al, Gd, Ti, Zr, Mg, Ca, Sr, Ba, Mg, Cr, Cu, Fe, Zn, V, Bi, Nb and B.

63. The process for recycling cathode active material from a battery of claim 62 wherein said E or said G is selected from the group consisting of Al and Gd.

64. The process for recycling cathode active material from a battery of claim 39 wherein said cathode active material and said recycled cathode active material have the same stoichiometry.

65. The process for recycling cathode active material from a battery of claim 39 wherein said cathode active material and said recycled cathode active material do not have the same stoichiometry.

66. The process for recycling cathode active material from a battery of claim 65 further comprising adding a virgin metal salt prior to said drying.

67. The process for recycling cathode active material from a battery of claim 66 wherein said virgin metal salt is a metal hydroxide or a metal carboxylate.

68. The process for recycling cathode active material from a battery of claim 66 wherein said virgin metal salt is a metal oxalate.

69. The process for recycling cathode active material from a battery of claim 39 wherein said carboxylic acid is a multicarboxylic acid.

70. The process for recycling cathode active material from a battery of claim 69 wherein said carboxylic acid is a dicarboxylic acid.

71. The process for recycling cathode active material from a battery of claim 39 wherein said carboxylic acid is selected from the group consisting of oxalic acid, acetic acid and malic acid.

72. The process for recycling cathode active material from a battery of claim 71 wherein said carboxylic acid is oxalic acid.

73. The process for recycling cathode active material from a battery of claim 39 wherein said virgin lithium salt is selected from the group consisting of lithium hydroxide and lithium carboxylate.

74. The process for recycling cathode active material from a battery of claim 39 wherein said digesting is at a temperature of no more than 100° C.

75. The process for recycling cathode active material from a battery of claim 39 wherein said digesting is at ambient pressure.
